(19) United States
(12) Patent Application Publication
(10) Pub. No.: US 2020/0008443 A1
(43) Pub. Date: Jan. 9, 2020

(54) CONFECTIONERY PRODUCT

(71) Applicant: Henry M. Whetstone, JR., St. Augustine, FL (US)

(72) Inventor: Henry M. Whetstone, JR., St. Augustine, FL (US)

(21) Appl. No.: 15/983,436

(22) Filed: Jul. 9, 2018

(51) Int. Cl. A23G 1/50; A63H 33/00

(52) U.S. Cl. CPC A23G 1/507; B65D 11/02; A63H 33/00

(57) ABSTRACT

A confectionery product comprises a two-section, non-edible housing defining a hollow interior adapted to receive a toy or other novelty item, and a layer of edible material covering approximately half of the outer surface of each section of the housing, while the other half is uncovered, in order to reduce the calories of the product and its cost.

### FIELD OF THE INVENTION

This invention relates to a confectionery product, and, more particularly, to a product having a two-section, non-edible housing defining a hollow interior adapted to receive a toy or other novelty item, and a layer of edible material covering a portion of each section of the housing but leaving another portion thereof exposed.

### BACKGROUND OF THE INVENTION

Small novelty items, miniature toys and edible snack items are commonly sold in containers formed of non-edible material such as plastic. Containers of this type may be egg-shaped or round and comprise two half sections which are releasably interconnected at their perimeter edges to form a hollow interior within which the toy or other item may be contained.

In addition to distributing candies and other confectionery items within containers such as described above, a variety of food packages have been introduced over the years to market and sell confectioneries. In many instances, the confectionery item is hollow and formed in a shape appealing to children, e.g. eggs or different animal shapes such as bunnies.

Both of the above-described packages or containers for marketing toy items and confectioneries suffer from limitations and deficiencies. Plastic containers having a prize or edible product in the interior often fail to capture the attention of children, even if decorated with bright color or distinctive designs. While hollow items made entirely of chocolate or other confectionery may attract attention, they can present problems of damage and waste when displayed at retail establishments. Consumers, and especially children, have a tendency to handle such items which may cause walls made of thin chocolate or the like to collapse. Although hollow confectioneries can be sold in protective boxes, cartons or trays, this adds significantly to the cost of such items and reduces the novelty appeal of the product.

One solution to these issues is found, for example, in U.S. Pat. Nos. 5,925,391 and 6,099,872. These patents disclose a product comprising two sections of plastic, each having a peripheral edge, which are releasably connected to one another at such edges to define a hollow interior that may receive a toy or, other novelty item. Each of the two sections is formed with a flange at its peripheral edge which, when the sections are interconnected, abut one another to collectively define a band extending around the circumference of the product which is raised from its outer surface. A layer of chocolate or other confectionery covers the entire outer surface of each section except for the raised band which is visible to provide an indication to the consumer that there is plastic material underneath the chocolate layer.

An issue with products of the type discussed above is that retailers and toy manufacturers are increasingly imposing requirements on chocolate manufacturers to reduce calories in their products in order to meet anti-obesity goals. Additionally, it is relatively costly to manufacture a product of this type wherein a chocolate layer is placed over essentially its entire surface area.

### SUMMARY OF THE INVENTION

This invention is directed to a confectionery product comprising a two-section, non-edible housing defining a hollow interior adapted to receive a toy or other novelty item, and a layer of edible material covering only approximately half of the outer surface of each section of the housing in order to reduce the calories of the product and its cost.

In a presently preferred embodiment, the housing of the product includes a first section and a second section each having a wall with inner and outer surfaces defining an interior and an open end. The first section is formed with a recess along its inner surface thereof, and the second section is formed with an outwardly extending tab along its outer surface. The two sections may be joined together by inserting the open end of the first section into the open end of the second section such that the tab of the second section engages the recess of the first section thus forming an enclosed interior which may receive a toy or novelty item.

Each of the first and second sections is formed with a flange which extends along its outer surface. Each flange defines two areas or portions of the outer surface of respective first and second sections. When the two sections are connected to one another, the flange of one section meets the flange of the other section collectively forming a seat. One portion of the outer surface of each section is located on one side of the seat and the other portion of the outer surface of each section is on the opposite side of such seat. A layer of chocolate covers that portion of each of the first and second sections which is located on one side of the seat, and the other portion of each of such sections on the opposite side of the seat are exposed. The entire product may be covered by a foil wrap.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a perspective view of the confectionery product of this invention with its outer foil wrap partially removed;

FIG. 2 is a cross sectional view of the product shown in FIG. 1 with a toy car in its interior;

FIG. 3 is a perspective view of one of the two sections forming the housing of the product;

FIG. 4 is a perspective view of the other of the sections forming the housing of the product;

FIG. 5 is an exploded, perspective view of the two sections of the housing, and a separate layer of confectionery, in position prior to assembly of the product;

FIG. 6 is a view similar to FIG. 5 except with the two sections of the housing assembled;

FIG. 7 is a perspective view of the fully assembly product here; and

FIG. 8 is a cross sectional view taken generally along line 8-8 of FIG. 6.

### DETAILED DESCRIPTION OF THE PREFERRED EMBODIMENT

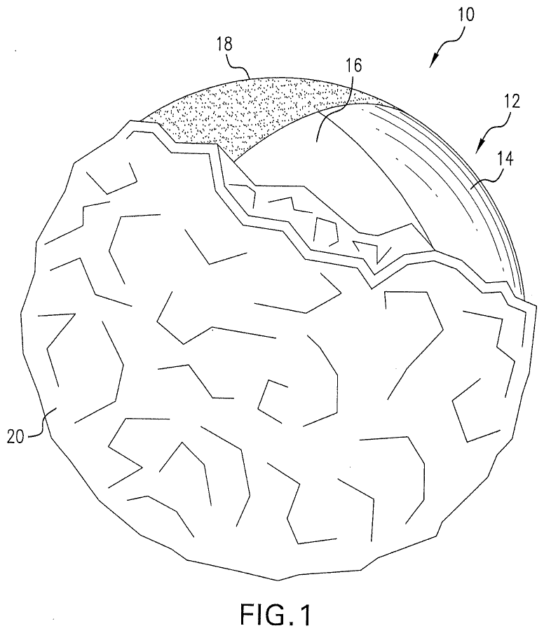

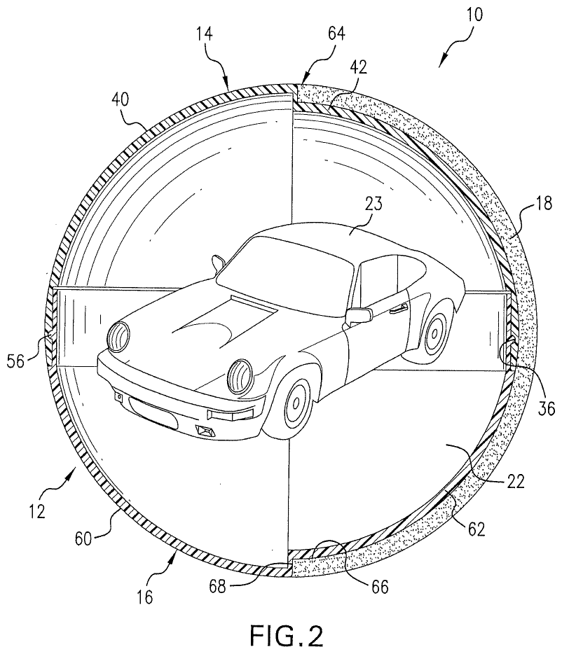

Referring initially to FIGS. 1 and 2, the confectionery product 10 of this invention comprises a housing 12 including a first section 14 and a second section 16 preferably formed of plastic or similar material. As discussed below, a portion of each of the first and second sections 14, 16 is covered by a layer 18 of confectionery material, such as chocolate, and the entire product 10 may be encased in a foil wrap 20 such as aluminum. The two sections 14, 16 of housing 12 are releasably interconnected in a manner described below to form a hollow interior 22 within which a toy car 23, or other novelty item, may be located. See FIG. 2.

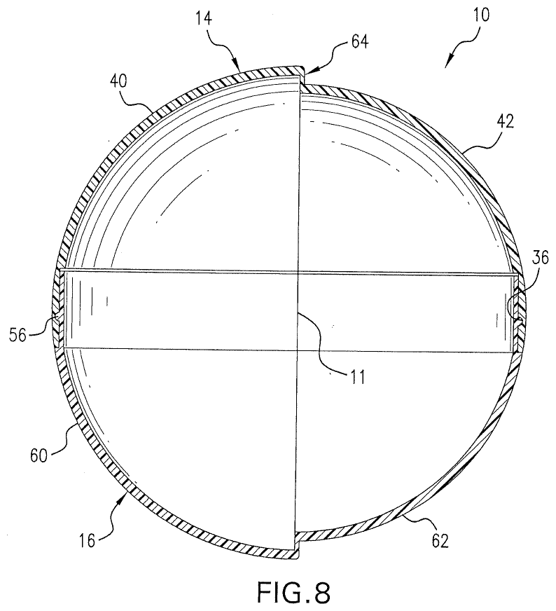

The product 10 is illustrated in the Figs. as a ball or sphere, but it should be understood that it could be constructed in essentially any other configuration such as egg-shaped, oval, square, rectangular, or, in the shape of any figure such as a rabbit or the like. Each of the individual elements of the product is discussed separately below. Further, throughout the following description, the terms “top,” “bottom,” “upper” and “lower” are meant to refer to directions and/or locations with the product 10 in the orientation shown in the Figs. The terms “inner” and “outer” refer to a radial relationship of structure beginning at a central axis 11 of the product 10 as depicted in FIG. 8.

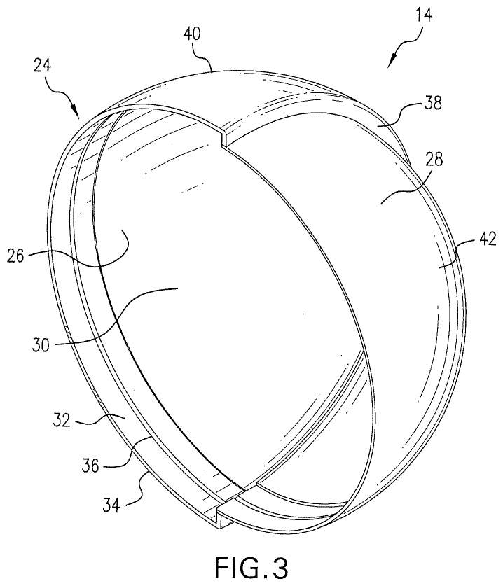

Referring now to FIG. 3, the first section 14 of housing 12 comprises a wall 24 having an inner surface 26 and an outer surface 28 defining an interior 30 and an open end 32 with a peripheral edge 34. A circumferentially extending recess 36 is formed along the inner surface 26 of the first section 14 spaced from its peripheral edge 34.

As best seen in FIGS. 3 and 8, the first section 14 is divided approximately in half by a flange 38 forming a first portion 40 and a second portion 42 of its outer surface 28. The flange 38 is defined by a step or offset in the wall 24 where the two portions 40, 42 meet. In the configuration of product 10 depicted in the Figs., wherein the housing 12 is in the shape of a ball or sphere, it can be seen that the circumference of the first portion 40 of the outer surface 28 is greater than the circumference of second portion 42. Expressed in other terms, the cross sectional area of the first portion 40 is greater than the cross sectional areal of second portion 42. As such, the flange 38 is raised, or extends in a direction radially outwardly, from the second portion 42 to the first portion 40 thereby defining a height dimension of such flange 38 as measured between the first and second portions 40, 42.

With the first section 14 in the orientation shown in FIG. 3, a vertical plane may be considered to be oriented coincident with the peripheral edge 34 of its open end 32. The flange 38 extends along the outer surface 28 of first section 14 from the upper part of its peripheral edge 34, in a direction substantially perpendicular to the vertical plane, to the lower part of peripheral edge 34 thus defining the first and second portions 40, 42 of outer surface 28.

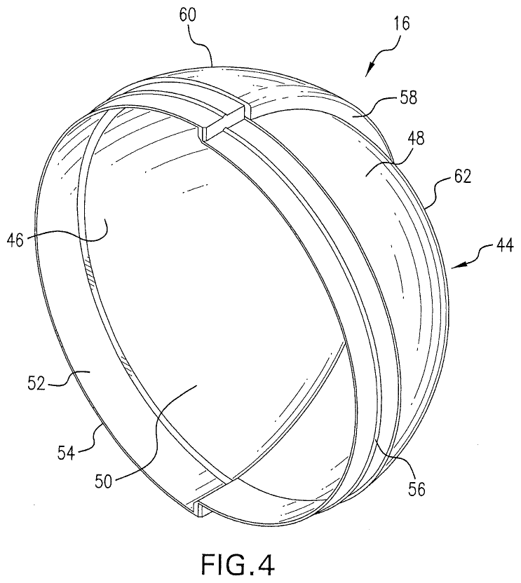

As illustrated in FIG. 4, the second section 16 of housing 12 comprises a wall 44 having an inner surface 46 and an outer surface 48 defining an interior 50 and an open end 52 with a peripheral edge 54. A circumferentially extending, raised tab 56 is formed along the outer surface 48 of the second section 16, spaced from its peripheral edge 54.

The second section 16 has a similar construction to that of the first section 14. It is divided approximately in half by a flange 58 forming a third portion 60 and a fourth portion 62 of its outer surface 48. The flange 58 is defined by a step or offset in the wall 44 where the two portions 60, 62 meet. In the configuration of product 10 depicted in the Figs., wherein the housing 12 is in the shape of a ball or sphere, it can be seen that the circumference of the third portion 60 of the outer surface 48, and its cross sectional area, are greater than the circumference and cross sectional area of fourth portion 62. As such, the flange 58 is raised, or extends in a direction radially outwardly, from the fourth portion 62 to the third portion 60 thereby defining a height dimension of such flange 58 which is the same as that of the flange 38 of the first section 14.

With the second section 16 in the orientation shown in FIG. 4, a vertical plane may be considered to be oriented coincident with the peripheral edge 54 of its open end 52. The flange 58 extends along the outer surface 48 of second section 16 from the upper part of its peripheral edge 54, in a direction substantially perpendicular to the vertical plane, to the lower part of peripheral edge 54 thus defining the third and fourth portions 60, 62 of outer surface 48.

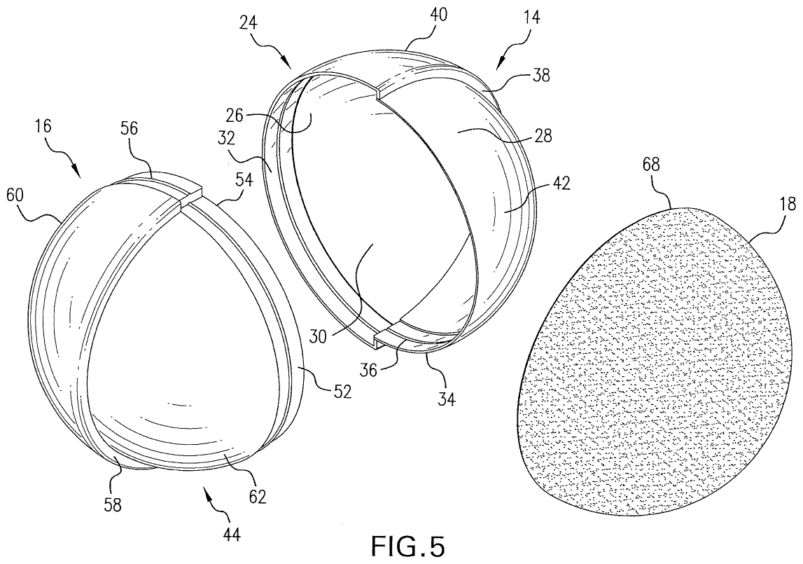

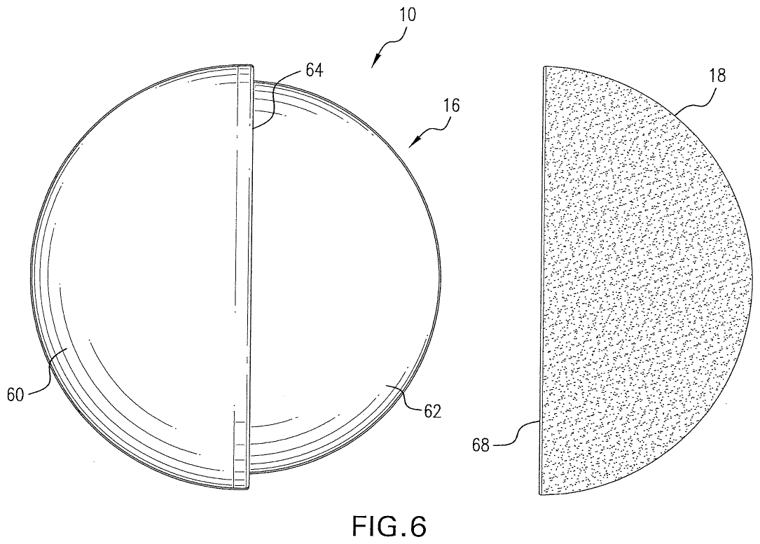

As viewed in the sequence illustration in FIGS. 5, 6 and 8, the first and second sections 14, 16 of housing 12 may be interconnected to form hollow interior 22. As best seen in FIG. 8, the open end 52 of second section 16 is inserted partially into the interior 30 of the first section 14 such that the tab 56 on the outer surface 48 of second section 16 engages the recess 36 in the inner surface 26 of first section 14. This releasably connects the first and second sections 14, 16 together. In this position, the upper and lower edges of flange 38 of first section 14 meet the upper and lower edges of flange 58 of second section 16 to collectively form a continuous seat 64 which extends about the circumference of the product 10 and has the same height dimension as the flanges 38, 58. With the first and second sections 14, 16 assembled, the first portion 40 of first section 14 and third portion 60 of second section 16 are located on one side of the seat 64, whereas the second portion 42 of first section 14 and fourth portion 62 of second section 16 are located on the opposite side of the seat 64.

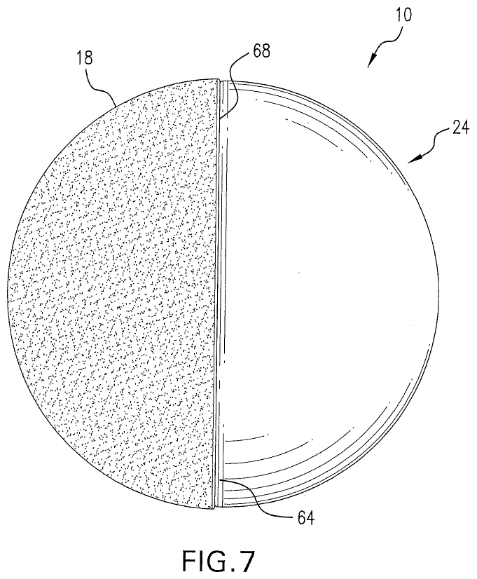

The final step in the assembly operation is depicted in FIGS. 2 and 7 wherein the chocolate layer 18 is affixed to the housing 12. The layer 18 comprises approximately one-half of a ball or sphere including an open end 66 having a peripheral edge 68, and a thickness equal to the height dimension of the seat 64. The layer 18 is placed over the second portion 42 of first section 14 and over the fourth portion 62 of second section 16 such that its peripheral edge 68 abuts the raised or radially outwardly extending part of the seat 64. Since the thickness of the layer 18 is the same as the height of seat 64, the layer 18 is substantially flush with the outer surface of the first portion 40 of first section 14 and with the outer surface of the third portion 60 of the second section 16.

It can be appreciated from the foregoing that essentially only one-half of the spherical-shaped housing 12 is covered with layer 18, and that a portion of each of the first and sections 14, 16, e.g. portions 42, 62, respectively, receive such layer 18. The other two portions 40, 60 of respective first and second sections 14, 16 are exposed.

While the invention has been described with reference to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, the Figs. illustrate a spherical-shaped product 10 but other configurations are considered within the scope of this invention as noted above. In such other configurations, the housing of the product comprises two sections with each section having a flange that defines two portions on the outer surface thereof of different cross sectional area such that a step or offset is formed in the wall of each section at the juncture of such portions. The flanges collectively define a seat, when the two sections are connected, with a layer of confectionery being received over one portion of each section on one side of the seat when assembly of the product is completed while the other portions of such sections have no confectionery layer.

Therefore, it is intended that the invention not be limited to the particular embodiment disclosed as the best mode contemplated for carrying out this invention, but that the invention will include all embodiments falling within the scope of the appended claims.

What is claim is:

1. An article, comprising:
a housing including a first section and a second section;
said first section comprising a first wall having an inner surface and an outer surface defining an interior and an open first end, said inner surface of said wall being formed with a recess, said first wall being formed with a first flange extending along said outer surface thereof defining a first portion and a second portion of said outer surface;
said second section comprising a second wall having an inner surface and an outer surface defining an interior and an open second end, said outer surface of said wall being formed with a tab, said second wall being formed with a second flange extending along said outer surface thereof defining a third portion and a fourth portion of said outer surface;
said second end of said second section being inserted within said interior of said first section so that said tab on said outer surface of said second wall engages said recess in said inner surface of said first wall thereby interconnecting said first and second sections to form a hollow enclosure adapted to receive an object, said first flange aligning with said second flange when said first and second sections are interconnected to collectively form a seat;
a layer of edible material extending over said second portion of said outer surface of said first section and over said fourth portion of said outer surface of said second section in position to abut said seat, said first and third portions of said outer surface of respective first and second sections being uncovered by said layer.

2. The article of claim 1 in which each of said first portion and said second portion of said first wall of said first section has a cross sectional area, said cross sectional area of said first portion being greater than said cross sectional area of said second portion.

3. The article of claim 2 in which said first flange is formed in said outer wall of said first section at the juncture of said first and second portions, said first flange extending outwardly from said second portion to said first portion.

4. The article of claim 1 in which each of said third portion and said fourth portion of said wall of said second section has a cross sectional area, said cross sectional area of said third portion being greater than said cross sectional area of said fourth portion.

5. The article of claim 4 in which said second flange is formed in said outer wall of said second section at the juncture of said third and fourth portions, said second flange extending outwardly from said fourth portion to said third portion.

6. The article of claim 1 in which said seat is formed by said first and second flanges along said second portion and said fourth portion of said outer surface of respective first and second sections, said seat having a height dimension which is substantially equal to a thickness of said layer of edible material.

7. The article of claim 1 in which said second portion of said first section and said fourth portion of said second section collectively comprise approximately one-half of said outer surface of said first and second walls, respectively.
